(19) United States
(12) Patent Application Publication
(10) Pub. No.: US 2014/0077974 A1
(43) Pub. Date: Mar. 20, 2014

(54) AIRCRAFT WARNING LIGHT AND AIRCRAFT WARNING LIGHT SYSTEM

(71) Applicant: TOSHIBA LIGHTING & TECHNOLOGY CORPORATION, Kanagawa (JP)

(72) Inventor: Shingo NIINO, Kanagawa (JP)

(73) Assignee: Toshiba Lighting & Technology Corporation, Kanagawa (JP)

(21) Appl. No.: 13/790,496

(22) Filed: Mar. 8, 2013

(30) Foreign Application Priority Data
Sep. 19, 2012 (JP) 2012-206176

(51) Int. Cl. B64F 1/00

(52) U.S. Cl. CPC B64F 1/00
USPC 340/953

(57) ABSTRACT

According to one embodiment, a control section controls a lighting circuit on the basis of a luminous intensity ratio table of a set rated current type to have a luminous intensity ratio corresponding to a current value detected by a current detecting circuit. The control section switches, according to a switch signal input from a power supply line, the luminous intensity ratio table to a luminous intensity ratio table of a rated current type corresponding to the switching signal.

### INCORPORATION BY REFERENCE

The present invention claims priority under 35 U.S.C. §119 to Japanese Patent Application No. 2012-206176 filed on Sep. 19, 2012. The content of the application is incorporated herein by reference in their entirety.

### FIELD

Embodiments described herein relate generally to an aircraft warning light employing a light-emitting element and an aircraft warning light system employing the aircraft warning light.

### BACKGROUND

In an airport, a plurality of aircraft warning lights are set in a runway, a taxiway, a track, and the like. An aircraft warning light system for controlling lighting of the aircraft warning lights and guiding airplanes is used.

In the aircraft warning light system, a constant current output from a constant current power supply device is supplied to, via a plurality of isolation transformers, a plurality of aircraft warning lights connected to the respective isolation transformers.

A luminous intensity ratio of the aircraft warning light set on the runway or the like is specified in a plurality of stages in the aircraft lamp electric facility job processing rules stipulated by the Civil Aviation Bureau. Luminous intensity of the aircraft warning light is adjusted to a predetermined luminous intensity ratio according to the length of the runway or the like, a period of time, and the like or meteorological conditions and the like. A relation between a current value of the constant current supplied from the constant current supply device and the luminous intensity ratio is set in advance. The constant current power supply device supplies a constant current having a current value corresponding to the luminous intensity ratio. The aircraft warning light detects the current value of the supplied constant current and controls the luminous intensity to a luminous intensity ratio corresponding to the current value.

As an aircraft warning light set in the existing runway, a bulb-type aircraft warning light employing a bulb as a light source is often used. Therefore, constant current power supply device sets, as a rated current, for example, 6.6 A necessary for lighting the bulb at a luminous intensity ratio of 100%. The constant current power supply device supplies, with reference to the rated current, a constant current having a current value corresponding to a luminous intensity ratio.

Recently, an LED-type aircraft warning light employing an LED element as a light source is proposed. In the case of the LED-type aircraft warning light, operation with a rated current lower than the rated current necessary for the bulb-type aircraft warning light is possible.

In the case of a plurality of taxiways or the like present in an airport, it is possible to carry out, at a time, work for replacing a plurality of existing bulb-type aircraft warning lights with LED-type aircraft warning lights by limiting the use of the taxiways. However, if only one runway is present depending on an airport, since there is temporal limitation for limiting the use of the runway or the like, it may be difficult to replace a plurality of existing bulb-type aircraft warning lights with LED-type aircraft warning lights at a time.

Therefore, if a plurality of existing bulb-type aircraft warning lights set in a runway or the like are replaced with LED-type aircraft warning lights, the bulb-type aircraft warning lights are replaced with the LED-type aircraft warning lights in order. The bulb-type aircraft warning lights and the LED-type aircraft warning lights are mixed in the same runways or the like until the replacement of all the bulb-type aircraft warning lights is completed. In such a situation in which the bulb-type aircraft warning lights and the LED-type aircraft warning lights are mixed, the rated current supplied from the constant current power supply device has to be a high rated current to match the bulb-type aircraft warning lights. Therefore, in the LED-type aircraft warning lights mixed with the bulb-type aircraft warning lights, luminous intensity control is performed according to a detected current value of a constant current on the basis of a relation between a current value of the constant current and a luminous intensity ratio based on the high rated current corresponding to the bulb-type aircraft warning lights.

However, even if the existing bulb-type aircraft warning lights set in the runway or the like are replaced with the LED-type aircraft warning lights in order and the replacement of all the bulb-type aircraft warning lights is completed, the LED-type aircraft warning lights perform the luminous intensity control while maintaining the relation between the current value of the constant current and the luminous intensity ratio based on the high rated current corresponding to the bulb-type aircraft warning lights.

This is because, in a plurality of LED-type aircraft warning lights set in a runway or the like, since there is temporal limitation that limits the use of the runway or the like, it is difficult to change, at a time, a relation between a current value of a constant current and a luminous intensity ratio from the high rated current corresponding to the bulb-type aircraft warning lights to a low rated current corresponding to the LED-type aircraft warning lights.

Therefore, although power saving is possible to replace the bulb-type aircraft warning lights with the LED-type aircraft warning lights, it is necessary to operate the LED-type aircraft warning lights while keeping the high rated current in the past. Since a power supply line for supplying the constant current from the constant current power supply device to the plurality of LED-type aircraft warning lights extends several kilometers, if the high rated current is kept, a power loss in the power supply line is large.

It is also possible to set a new signal line connected to the plurality of LED-type aircraft warning lights and switch, at a time, the relation between the current value of the constant current and the luminous intensity ratio from the high rated current corresponding to the bulb-type aircraft warning lights to the low rated current corresponding to the LED-type aircraft warning lights through the signal line. However, the signal line is to be set anew.

### BRIEF DESCRIPTION OF THE DRAWINGS

FIG. 1 is a circuit diagram of an aircraft warning light and an aircraft warning light system according to an embodiment;

FIG. 2 is an explanatory diagram of a luminous intensity ratio table according to the embodiment; and

FIG. 3 is a flowchart concerning control of the aircraft warning light.

### DETAILED DESCRIPTION

An aircraft warning light according to an embodiment converts, with a lighting circuit, a constant current input from a power supply line into alighting current corresponding to a predetermined luminous intensity ratio and supplies the lighting current to a light-emitting element. A current detecting circuit detects a current value of the constant current input from the power supply line. A control section includes a plurality of kinds of luminous intensity ratio tables in which a relation between a current value of the constant current and a luminous intensity ratio is set for each of different rated current types of the constant current. The control section controls the lighting circuit on the basis of a luminous intensity ratio table of a set rated current type to have a luminous intensity ratio corresponding to the current value detected by the current detecting circuit. The control section switch, according to a predetermined switch signal input from the power supply line, the luminous intensity ratio table to a luminous intensity ratio table of a rated current type corresponding to the switching signal.

According to the input of the predetermined switching signal from the power supply line, the aircraft warning light switches the luminous intensity ratio table to the luminous intensity ratio table of the rated current type corresponding to the switching signal. Therefore, it is possible to easily cope with a reduction in the rated current of the aircraft warning light and it is possible to expect that a power loss in the power supply line is reduced without setting another signal line.

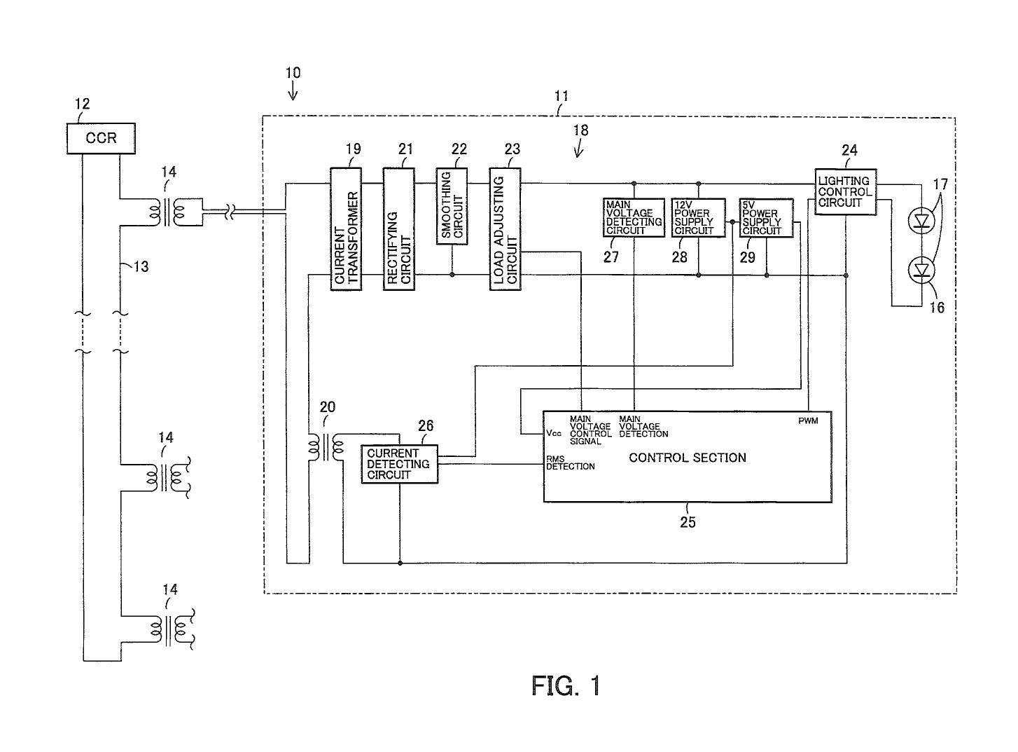

An embodiment is explained with reference to FIGS. 1 to 3.

As shown in FIG. 1, an aircraft warning light system 10 controls lighting of a plurality of aircraft warning lights 11 set in a runway, a taxiway, and the like of an airport.

The aircraft warning light system 10 includes a constant current power supply device (CCR) 12 configured to supply an alternating constant current as a constant current. A primary side of a plurality of isolation transformers 14 such as rubber-coated isolation transformers is connected in series to a power supply line 13 for outputting the alternating constant current from the constant current power supply device 12. One or a plurality of aircraft warning lights 11 are connected to a secondary side of the respective isolation transformers 14 in series.

The aircraft warning light 11 includes a plurality of LED elements 17 functioning as light-emitting elements 16 connected in series and a lighting circuit 18 configured to convert the alternating constant current input from the power supply line 13 into a direct-current constant current, which is a lighting current, corresponding to a predetermined luminous intensity ratio and supply the direct-current constant current to the LED elements 17. The LED elements 17 are arranged in combination with an optical component in a lighting instrument of the aircraft warning light 11. However, the lighting circuit 18 may be arranged in the lighting instrument or may be arranged in a place separate from the lighting instrument. The light-emitting elements 16 are not limited to the LED elements 17 and may be other solid-state light-emitting elements such as EL elements.

In the lighting circuit 18, a primary side of a current transformer 19 and a primary side of a current transformer 20 are connected in series to a secondary side of the isolation transformer 14.

The current transformer 19 converts the alternating constant current input from the isolation transformer 14 into a predetermined current value lower than a current value of the alternating constant current and outputs the alternating constant current from a secondary side. A rectifying circuit 21 configured to rectify the alternating constant current and a smoothing circuit 22 configured to smooth the alternating constant current are connected to the secondary side of the current transformer 19. Further, a load adjusting circuit 23 configured to adjust an electric current supplied to the LED elements 17 to a predetermined current value and a lighting control circuit 24 configured to control the electric current supplied to the LED elements 17 according to a luminous intensity ratio are connected.

The load adjusting circuit 23 is subjected to feedback control on the basis of a detection voltage of a main voltage detecting circuit 27 explained below. The load adjusting circuit 23 converts, with means for, for example, bypassing a part of an electric current, an applied voltage to the LED elements 17 into a constant voltage not to exceed a predetermined value, for example, 27 V.

The lighting control circuit 24 includes a switching element. The switching element is subjected to PWM (pulse width modulation) control by a control section 25, whereby the lighting control circuit 24 controls an electric current supplied to the LED elements 17 to set the luminous intensity of the LED elements 17 to luminous intensity corresponding to a predetermined luminous intensity ratio.

A current detecting circuit 26 configured to detect a current value of an alternating constant current input from the power supply line 13 is connected to a secondary side of the current transformer 20. The current value of the alternating constant current detected by the current detecting circuit 26 is input to the control section 25. The control section 25 controls the lighting control circuit 24 as explained above according to the input current value.

The main voltage detecting circuit 27, a 12V power supply circuit 28, and a 5V power supply circuit 29 are connected between the load adjusting circuit 23 and the lighting control circuit 24. A main voltage detected by the main voltage detecting circuit 27 is input to the control section 25. The control section 25 adjusts an output voltage of the load adjusting circuit 23 as explained above. A 12V operating voltage is supplied from the 12V power supply circuit 28 to the current detecting circuit 26. A 5V operating voltage is supplied from the 5V power supply circuit 29 to the control section 25.

In the aircraft warning light system 10, a relation between a current value of the alternating constant current supplied from the constant current power supply device 12 and a luminous intensity ratio is set in advance. The constant current power supply device 12 and each of the aircraft warning lights 11 store the relation between the current value of the alternating-current constant current and the luminous intensity ratio. In the aircraft warning light 11, the relation is stored in a storing section of the control section 25.

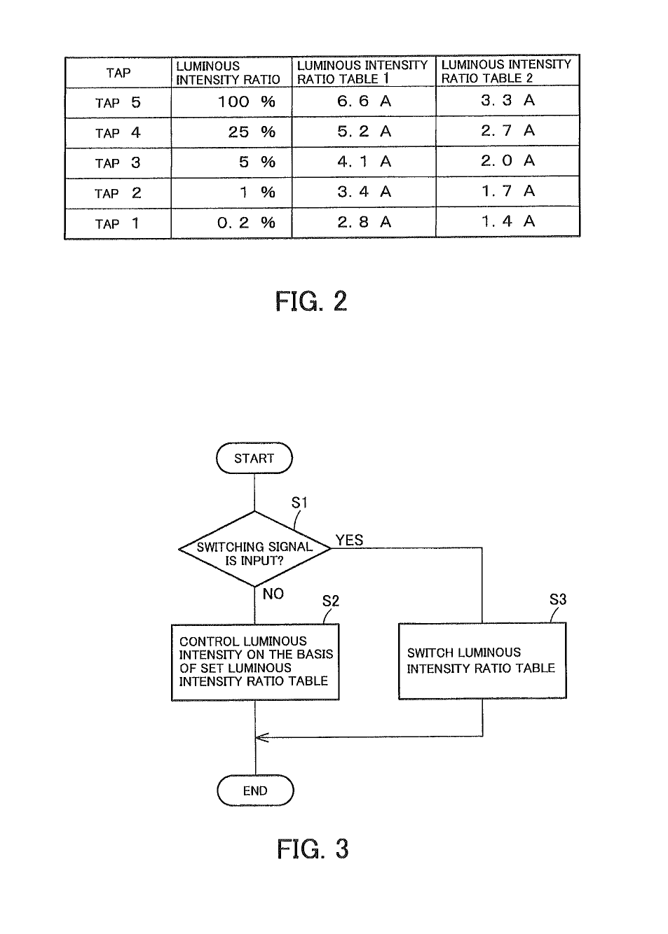

An example of a luminous intensity ratio table stored in the storing section of the control section 25 is shown in FIG. 2. In the case of the aircraft warning light 11 in the runway, there are five stages of the luminous intensity ratio from a tap 1 to a tap 5. The tap 5 is set to a luminous intensity ratio of 100%, the tap 4 is set to a luminous intensity ratio of 25%, the tamp 3 is set to a luminous intensity ratio of 5%, the tap 2 is set to a luminous intensity ratio of 1%, and the tap 1 is set to a luminous intensity ratio of 0.2%. The luminous intensity ratio 100% of the tap 5 is set as a rated current. The storing section includes two kinds of luminous intensity ratio table in which the rated current is set at the luminous intensity ratio of 100% in the tap 5, i.e., a luminous intensity ratio table 1 in which the rated current is 6.6 A and a luminous intensity ratio table 2 in which the rated current is 3.3 A. The luminous intensity ratio table 1 and the luminous intensity ratio table 2 are different in only the rated currents. There is no change in the luminous intensity ratios in the taps 1 to 5. In the luminous intensity ratio table 1, the rated current corresponds to an aircraft warning light employing a bulb. In the luminous intensity ratio table 2, the rated current is suitable for the aircraft warning light 11 employing the LED elements 17. The constant current power supply device 12 also stores such association of the taps 1 to 5 and the luminous intensity ratio tables 1 and 2.

Further, the constant current power supply device 12 outputs a switching signal for switching the luminous intensity ratio table 1 to the luminous intensity ratio table 2 from the power supply line 13 to the aircraft warning light 11. The aircraft warning light 11 detects the switching signal input through the power supply line 13 to thereby switch the luminous intensity ratio table 1 and the luminous intensity ratio table 2. The switching signal is, for example, a pattern in which ON and OFF of the output of the alternating constant current is repeated a plurality of times in a fixed period set in advance, a pattern in which a current value is sequentially switched to current values of the taps 5, 4, 3, 2, and 1 within a fixed period set in advance, and a pattern in which a half cycle of the alternating-current power supply voltage is intermittently deleted during a predetermined period. These patterns are impossible in the supply of an alternating constant current in a normal operation.

If a bulb-type aircraft warning light employing a bulb is set in the existing runway, the constant current power supply device 12 sets 6.6 A as a rated current and supplies, based on the rated current 6.6 A, an alternating constant current having a current value corresponding to a luminous intensity ratio from the power supply line 13 to the bulb-type aircraft warning light. The bulb-type aircraft warning light detects the current value of the alternating-current constant current supplied based on the rated current 6.6 A and controls luminous intensity to a luminous intensity ratio corresponding to the detected current value.

If the bulb-type aircraft warning light set in the existing runway is replaced with the LED-type aircraft warning light 11 employing the LED elements 17, a plurality of the bulb-type aircraft warning lights are replaced with a plurality of the LED-type aircraft warning lights 11 in order. A situation occurs in which the bulb-type aircraft warning lights and the LED-type aircraft warning lights 11 are mixed in the same runways until the replacement of all the bulb-type aircraft warning lights is completed. In such a situation in which the bulb-type aircraft warning lights and the LED-type aircraft warning lights 11 are mixed, the rated current supplied from the constant current power supply device 12 has to be a rated current 6.6 A adapted to the bulb-type aircraft warning lights.

If the LED-type aircraft warning light 11 is set while being mixed with the bulb-type aircraft warning light in the power supply line 13, the luminous intensity ratio table 1 corresponding to the rated current 6.6 A is set in the control section 25 of the LED-type aircraft warning light 11.

In the LED-type aircraft warning light 11, as shown in the flowchart of FIG. 3, the control section 25 detects a current value of an alternating constant current supplied from the power supply line 13 and monitors whether a switching signal is input (Act 1). If the switching signal is not input, the control section 25 controls luminous intensity to a luminous intensity ratio corresponding to the detected current value based on the luminous intensity ratio table 1 corresponding to the set rated current 6.6 A (Act 2). In this case, in the LED-type aircraft warning light 11, the load adjusting circuit 23 bypasses a relatively large current and fixes an applied voltage to the LED elements 17.

If all the aircraft warning lights 11 connected to the power supply line 13 are replaced with the LED type, the control section 25 performs switching work for switching the rated current 6.6 A used in the aircraft warning light system 10 to a rated current 3.3 A. The switching work is performed, for example, in a period of time when the runway is not used.

In the switching work, the constant current power supply device 12 outputs a switching signal to the aircraft warning light 11 through the power supply line 13. The switching signal is, for example, a pattern in which ON and OFF of the output of the alternating constant current is repeated a plurality of times in a fixed period set in advance and a pattern in which a current value is sequentially switched to current values of the taps 5, 4, 3, 2, and 1 within a fixed period set in advance. These patterns are impossible in the supply of an alternating constant current in a normal operation.

In the aircraft warning light 11, if the control section 25 determines that the switching signal is input (YES in Act 1), the constant current power supply device 12 switches the luminous intensity ratio table 1 corresponding to the rated current 6.6 A to the luminous intensity ratio table 2 corresponding to the rated current 3.3 A (Act 3).

Thereafter, the constant current power supply device 12 switches the rated current 6.6 A to the rated current 3.3 A and supplies, based on the rated current 3.3 A, an alternating constant current having a current value corresponding to a luminous intensity ratio from the power supply line 13 to the LED-type aircraft warning light 11.

In the LED-type aircraft warning light 11, the control section 25 controls luminous intensity to a luminous intensity ratio corresponding to the detected current value based on the luminous intensity ratio table 2 corresponding to the switched rated current 3.3 A. In this case, in the LED-type aircraft warning light 11, the load adjusting circuit 23 can bypass a relatively small current and fixed an applied voltage to the LED elements 17. That is, it is possible to reduce a power loss in the aircraft warning light 11.

The power supply line 13 for supplying the alternating constant current from the constant current power supply device 12 to the plurality of LED-type aircraft warning lights 11 extends several kilometers. However, it is possible to reduce a power loss in the power supply line 13 by reducing a rated current.

In the aircraft warning light 11 configured as explained above, if a predetermined switching signal is input from the power supply line 13, the luminous intensity ratio table is switched to a luminous intensity ratio table of a rated current type corresponding to the switching signal. Therefore, it is possible to easily switch the luminous intensity ratio table without setting another signal line.

Therefore, in the aircraft warning light system 10, since the aircraft warning light 11 is used, if the bulb-type aircraft warning lights set in the existing runway are replaced with the LED-type aircraft warning lights 11 in order, after all the bulb-type aircraft warning lights are replaced, it is possible to switch luminous intensity ratio tables of the plurality of aircraft warning lights 11 at a time and reduce a rated current. Since the rated current is reduced, it is possible to reduce a power loss in the power supply line 13 and realize a reduction in electric power.

The luminous intensity ratio table corresponding to the LED-type aircraft warning light 11 is not limited to the luminous intensity ratio table 2 for the rated current 3.3 A. For example, the luminous intensity ratio table may be a luminous intensity ratio table in which a rated current is set to 4.0 A, a current value of the tap 5 is set to 4.0 A, a current value of the tap 4 is set to 3.5 A, a current value of the tap 3 is set to 3.0 A, a current value of the tap 2 is set to 2.5 A, and a current value of the tap 1 is set to 2.0 A. A luminous intensity ratio table corresponding to a type of the aircraft warning light 11 only has to be set.

For transmission of the switching signal from the constant current power supply device 12 to the aircraft warning light 11 through the power supply line 13, a power-line carrier communication system for superimposing a signal on an alternating-current waveform may be used. If the power-line carrier communication system is used, a detecting section configured to detect a power-line carrier signal only has to be included in the aircraft warning light 11.

Various modifications of the lighting circuit 18 are possible. For example, instead of the load adjusting circuit 23 and the lighting control circuit 24, an output variable falling voltage chopper, a falling voltage chopper, and the like may be used. Outputs of the choppers may be controlled according to a current value of a constant current.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. An aircraft warning light comprising:
a light-emitting element;
a lighting circuit configured to convert a constant current input from a power supply line into a lighting current corresponding to a predetermined luminous intensity ratio and supply the lighting current to the light-emitting element;
a current detecting circuit configured to detect a current value of the constant current input from the power supply line; and
a control section including a plurality of kinds of luminous intensity ratio tables in which a relation between a current value of the constant current and a luminous intensity ratio is set for each of different rated current types of the constant current and configured to control the lighting circuit on the basis of a luminous intensity ratio table of a set rated current type to have a luminous intensity ratio corresponding to the current value detected by the current detecting circuit and switch, according to a predetermined switch signal input from the power supply line, the luminous intensity ratio table to a luminous intensity ratio table of a rated current type corresponding to the switching signal.

2. The light according to claim 1, wherein the switching signal is a pattern in which ON and OFF of the constant current is repeated in a predetermined period.

3. The light according to claim 1, wherein the switching signal is a pattern in which a current value of the constant current is switched in a predetermined period.

4. The light according to claim 1, wherein the switching signal is a signal superimposed on an alternating current waveform.

5. The light according to claim 1, wherein the luminous intensity ratio tables of the rated current types include a luminous intensity ratio table in which a rated current is 6.6 A and a luminous intensity ratio table in which a rated current is smaller than 6.6 A.

6. An aircraft warning light system comprising:
a aircraft warning light including a light-emitting element, a lighting circuit configured to convert a constant current input from a power supply line into a lighting current corresponding to a predetermined luminous intensity ratio and supply the lighting current to the light-emitting element, a current detecting circuit configured to detect a current value of the constant current input from the power supply line, and a control section including a plurality of kinds of luminous intensity ratio tables in which a relation between a current value of the constant current and a luminous intensity ratio is set for each of different rated current types of the constant current and configured to control the lighting circuit on the basis of a luminous intensity ratio table of a set rated current type to have a luminous intensity ratio corresponding to the current value detected by the current detecting circuit and switch, according to a predetermined switch signal input from the power supply line, the luminous intensity ratio table to a luminous intensity ratio table of a rated current type corresponding to the switching signal; and
a constant current power supply device configured to supply the constant current of the set rated current type and having a current value corresponding to a predetermined luminous intensity ratio from the power supply line to the aircraft warning light and, in switching the rated current type, output the switching signal from the power supply line to the aircraft warning light.

7. The system according to claim 6, wherein the switching signal is a pattern in which ON and OFF of the constant current is repeated in a predetermined period.

8. The system according to claim 6, wherein the switching signal is a pattern in which a current value of the constant current is switched in a predetermined period.

9. The system according to claim 6, wherein the switching signal is a signal superimposed on an alternating current waveform.

10. The system according to claim 6, wherein the luminous intensity ratio tables of the rated current types include a luminous intensity ratio table in which a rated current is 6.6 A and a luminous intensity ratio table in which a rated current is smaller than 6.6 A.
